(19) United States
(12) Patent Application Publication
(10) Pub. No.: US 2015/0241545 A1
(43) Pub. Date: Aug. 27, 2015

(54) Single Platform Doppler Geolocation

(71) Applicant: Lockheed Martin Corporation, Bethesda, MD (US)

(72) Inventors: Norman August Lehtomaki, Edmonds, WA (US); T. Craig Poling, Eden Prairie, MN (US); Douglas A. Schuyler, Westminster, CO (US)

(73) Assignee: Lockheed Martin Corporation, Bethesda, MD (US)

(21) Appl. No.: 14/189,216

(22) Filed: Feb. 25, 2014

(51) Int. Cl. G01S 3/14

(52) U.S. Cl. CPC G01S 3/14

(57) ABSTRACT

To make small UAVs capable of geolocation of emitters, a low cost, low power, small weight and power radio receiver receives and tracks Doppler frequency at a minimum. In order to minimize the size, weight and power (SWAP), a single receiving element array is utilized. The analysis of geolocation performance with single and multiple UAV receiving platforms is considered. With a single UAV platform measuring Doppler frequency with unknown center frequency, a localization accuracy on the order of ten to 100 meters is possible within a couple of minutes, or about one to five percent of the target range.

### BACKGROUND

1. Field

This invention relates generally to vehicle-mounted geolocation system. More particularly, this invention relates to a light size and weight system that consumes little power when it locates the position of emitters of electromagnetic radiation.

2. Description of Related Art Including Information Disclosed Under 37 CFR 1.97 and 1.98

In the field, troops do not have an effective tactical asset under troop control that is capable of locating hostile emitters that emit signals to communicate and/or control equipment under the control of a hostile entity. Geolocation using time difference of arrival (TDOA) or frequency difference of arrival (FDOA) techniques typically require multiple platforms that are synchronized in time or frequency so that differences between platforms can be calculated. Usually, this synchronization is done with atomic clocks or synchronized stable local oscillators. Synchronization also requires electronics that consume more power or weigh more than can be carried by a small unmanned air vehicle (UAV) while maintaining persistence requirements and maintaining flight control stability. Another alternative for geolocation from a single platform require multiple element antennas to determine angles of arrival of the signals in order to determine a target angular location. These solutions may provide simple azimuth information, but fails to provide any information regarding range. More complex arrays could provide azimuth and elevation that could be used to determine range and azimuth. However, complex arrays require calibration and consume power. Additionally, complex arrays weigh more and potentially affect aerodynamics, diminishing the flight control system performance of a small tactical UAV. As such, these solutions can only be incorporated into larger platforms not under the control of the end user (troops in the field) and can only be taken advantage of using multiple airborne platforms, if available, even though they may not be tightly synchronized in time down the carrier phase level.

### SUMMARY

A geolocation system for identifying a location of an emitting source is disclosed wherein the geolocation system is hosted by a moving craft. The geolocation system includes an omnidirectional antenna used to collect source signals emitted by the emitting source. A signal processor is an electrical communication with the antenna and receives the source signals collected by the antenna. The signal processor extracts frequency data from the source signals. A frequency estimator is electrically connected to the signal processor. The frequency estimator estimates a frequency of the source signals independent of a center frequency or a frequency drift rate of the source signals. A controller calculates the location of the emitter source based upon the frequency estimator output.

### DRAWING DESCRIPTIONS

FIG. 1 is a perspective environmental view of a geolocation system of the prior art;

FIG. 2 is a perspective environmental view of a geolocation system according to one embodiment of the invention hosted by an aircraft;

FIG. 2 is a block diagram of one embodiment of the invention;

FIG. 3 is a block diagram of one embodiment of the inventive system;

FIG. 4 is a block diagram of a frequency estimator according to one embodiment of the invention;

FIG. 5 is a block diagram of the inventive method; and

FIG. 6 is a logic chart of one embodiment of the inventive method.

### DETAILED DESCRIPTION

Aircraft have been used for tactical reconnaissance for almost as long as aircraft have been in existence. As technology changed, so too did the type of information gathered as well as how it was gathered. With the advent of UAVs, targets that are less permanent in nature have been easier to locate. This is because the UAV may be able to get closer to the target without being discovered.

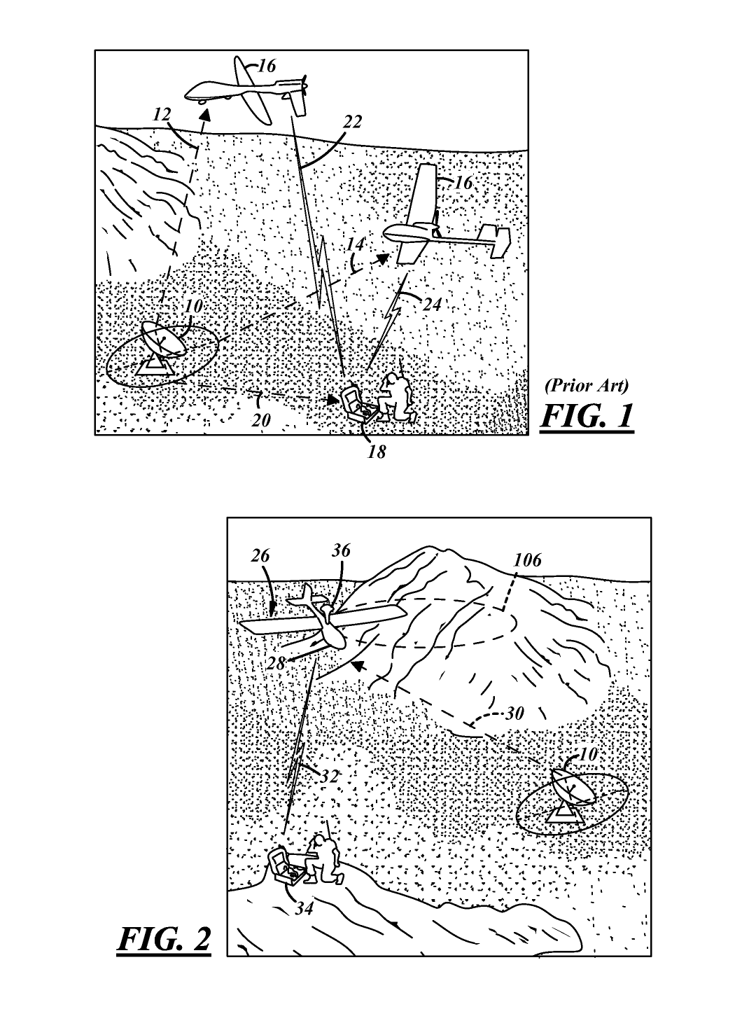

Referring to FIG. 1, a graphic representation of how UAVs were used prior to the invention is shown. In this situation, a target 10 is graphically represented as a satellite antenna and is a surrogate for any type of emitter even as simple as a handheld radio transceiver. It should be appreciated by those skilled in the art that the unknown emitter may be attached to a permanent structure or it may be an emitting device that is mobile. Signals transmitted by the target antenna are graphically represented by arrows 12, 14. The signals 12, 14 are received by antenna (not shown) hosted by a plurality of UAVs 16. In addition, a land-based receiving station 18 may also receive a signal 20 emitted by the target at 10. Information from the plurality of UAVs 16 is transmitted (graphically represented by lightning symbols 22, 24) to the land-based receiving station 18. With the information transmitted by the plurality of UAVs 16 and in addition to the signal 20 received by the land-based receiving station 18, the land-based receiving station 18 may calculate the location of the target antenna 10. This system is cumbersome in that it requires the synchronization of all the plurality of UAVs 16 as well as having the personnel required to control and operate the UAVs 16.

Referring to FIG. 2, one embodiment of the inventive assembly is generally indicated at 26. Like the plurality of UAVs 16 in the prior art shown in FIG. 1, a UAV 28 receives a signal 30 of electromagnetic radiation from the target antenna 10. After the UAV 28 receives the signal 30, it transmits the signal (graphically represented by lightning symbol 32) to a land-based receiving station 34, which then calculates the location of the target antenna 10. The UAV 28 includes a single monopole antenna 36 consisting of a simple omnidirectional element array designed to receive the signal 30 from the target antenna 10. An omnidirectional element array is an antenna that receives signals uniformly in all directions in one plane. These omnidirectional element arrays may be monopole or dipole antennas. Use of the simple omnidirectional element array reduces the size, weight and power (SWAP) of the geolocation system 26. The design of the single, monopole antenna 36 will hereinafter be referred to as an omnidirectional antenna 36. The operation of the UAV 28 will be discussed in greater detail subsequently. It should be appreciated by those skilled in the art that the craft disclosed as UAV 28 may be any type of craft or vehicle as the invention can be utilized with any moving platform.

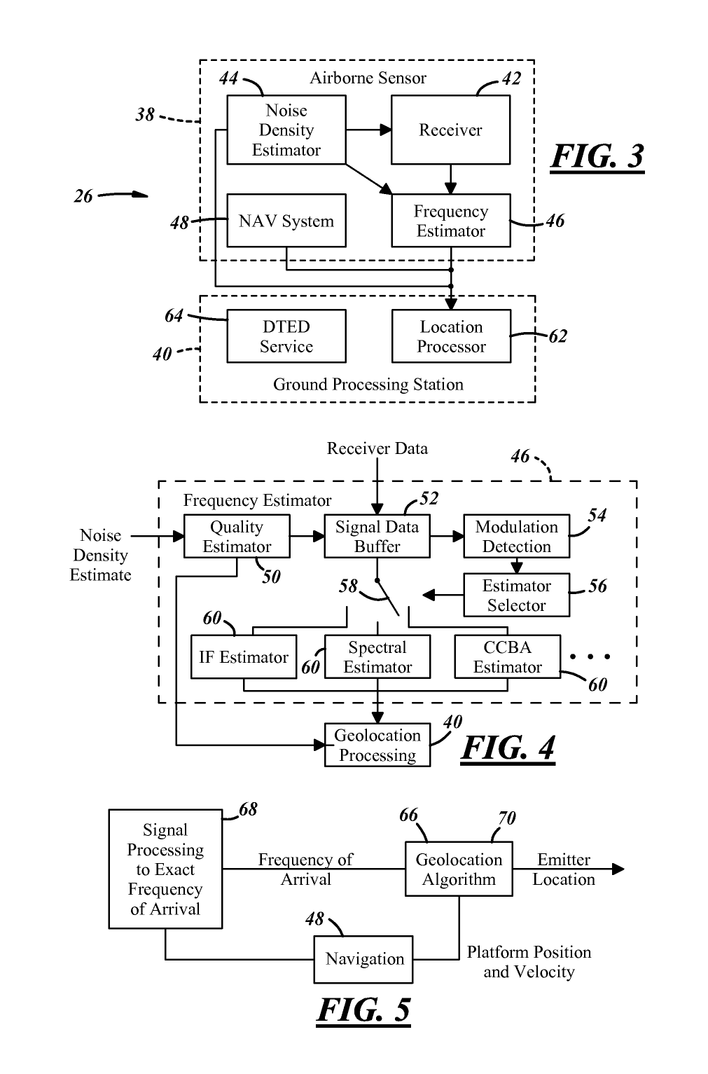

Referring to FIG. 3, a block diagram of the inventive assembly 26 is generally shown. The geolocation system includes an airborne sensor 38, which is hosted by the UAV 28 in FIG. 2, and a computerized ground processing station 40, which is graphically represented by the land-based receiving station 34 in FIG. 2. The airborne sensor 38 receives the signal 30 using a digital receiver 42. The signal may be analog or digital, consistent or intermittent. The communication rate may be low and the geolocation system 26 will account for low communication rate. The signal received by the digital receiver 28 from the omnidirectional antenna 36 is sent to both a noise density estimator 44 and a frequency estimator 46. The noise density estimator 44 measures the signal-to-noise ratio (SNR) and sends the measured SNR to both the frequency estimator 46 and the ground processing station 40. The airborne sensor 38 also includes a navigation system 48. The output of the navigation system 48 is also sent to the ground processing station 40, which hosts at least one computer that will process the outputs received.

Referring to FIG. 4, a more detailed representation of the computerized frequency estimator 46 is shown. As stated above, the frequency estimator 46 receives inputs from the digital receiver 42 and the noise density estimator 44. A quality estimator 50 receives the output of the noise density estimator 44. The output of the quality estimator 50 is received by a signal data buffer 52. The signal data buffer 52 also receives the output of the digital receiver 42. A modulation detector 54 detects how the signal received by the digital receiver 42 is modulated. This is required because the geolocation system 26 is going to be required to detect signals of unknown frequency. Based on the output of the modulation detector 54, an estimator selector 56 selects, as is graphically represented by a switch 58 between a plurality of estimators 60 to select the proper estimator for the signal 30 received by the digital receiver 42. While three estimators 60 are shown in FIG. 4, it should be appreciated by those skilled in the art that any number of estimators may be used to estimate the frequency of the signal 30 received by the digital receiver 42. The output of the frequency estimator 46 is sent to the computerized ground processing station 40, identified in FIG. 4 as the geolocation processing.

Returning attention to FIG. 3, the ground processing station 40 includes an emitter location processor 62 (this processor may be part of the airborne platform or the ground station processing as depicted) that receives all of the outputs of the airborne sensor 38. The emitter location processor 62 may receive outputs from a plurality of airborne sensors 38 (one shown) and does not require multiple platform synchronization (timing on the order of 0.1 second is all that is required).

The location processor 62 receives outputs from the noise density estimator 44, the navigation system 48, and the frequency estimator 46. Together with a database incorporating the digital terrain elevation data 64, the ground processing station 40 can identify the location of the target 10. The digital terrain elevation data 64, is not absolutely necessary, but may improve the geolocation height estimate.

Referring to FIG. 5, a graphic representation of a data flow for a method utilized by the geolocation system 26 is generally shown at 66. Signal processing occurs at 68 to extract the frequency of arrival for a particular signal 30. The signal processing includes information received from the navigation system 48. The frequency of arrival information and the platform position and velocity information from the navigation system 48 are incorporated as inputs into a geolocation algorithm 70, which then identifies the location of the target emitter 10.

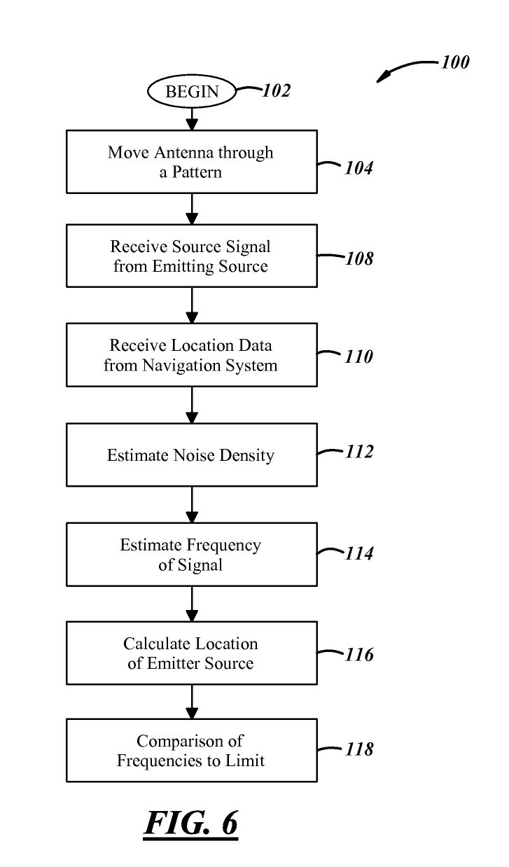

Referring to FIG. 6, one embodiment of the inventive method is graphically shown in a flow chart, generally indicated at 100. The method begins at 102. The first step in the method 100 is to move the omnidirectional antenna 36 through a pattern at 104. The pattern is graphically shown in FIG. 2 as a circle 106. Depending on the conditions or the type of signal to be collected, the pattern 106 may be something other than a circle pattern. Regardless of the shape of the pattern, the pattern 106 may be repeated or only a portion of the pattern may be utilized. Performance is dependent on the specific platform-emitter geometry over the time interval of data collection.

As the omnidirectional antenna 36 is moved through a pattern, a source signal is received from the emitting source or target 10 at 108. The system also receives location data from a navigation system at 110. Noise density is calculated from the source signal as it is received from the emitting source 10 at 112.

The frequency of the source signal is estimated at 114. Because the omnidirectional antenna 36 is used to identify the geolocation of the emitting source or target antenna 10, estimating the frequency of the signal at 114 requires identifying the frequency of the signal source that is affected by the Doppler frequency shift based on the location and movement of the omnidirectional antenna 36. To do this, a calculation of time dilation must be made since the Doppler shift is itself time varying. Ignoring amplitude changes, the relationship between transmitted and received signals is:

cτ(t)=|\vec{r}_{R}(t+τ(t))−\vec{r}_{T}(t)| (1)

where letter c is the speed of wave propagation, τ(t) denotes the value of travel time and \vec{r}_{T}(t) and \vec{r}_{R}(t) are position vectors of the transmitter and receiver, respectively. In addition to time dilation, the average Doppler frequency shift over the same period of time must be calculated. This is done using the following equation:

$$\begin{matrix}{Δ}_{favg} ( t ) = \frac{1}{T} {\int }_{t - T / 2}^{t + T / 2} Δ f ( s ) d s \\ = \frac{[ {r}_{RT} ( t + T / 2 ) - {r}_{RT} ( t - T / 2 ) ]}{λ T}\end{matrix} \qquad ( 2 )$$

where r_{RT}(t) is the distance between the platform receiver and the unknown transmitter (emitter), λ is the wavelength and Δf(t) is the instantaneous Doppler frequency shift at time t.

When considering the case of a stationary emitter 10, the average Doppler shifts correspond to scaled range difference measurements (or TDOA) for positions of the receiver at the beginning and end of the time interval for the average. The equivalent time differences are:

$$τ ( t + T / 2 ) - τ ( t - T / 2 ) = - \frac{T}{{f}_{0}} Δ {f}_{avg} ( t ) . \qquad ( 3 )$$

This observation is important since Doppler emitter localization performed here is based on range difference processing over a synthetic aperture. The approach used here in one implementation is a completely linear TDOA or range difference solution, even for a single platform. This linear formulation can be used as a starting point for iterative refinement by including additional non-linear equations. Nevertheless, using the average Doppler shifts, emitter locations can be computed using a standard TDOA overdetermined set of linear equations. In this simple formulation, the use of range differences assumes f₀ or λ are known. This is not essential and the method is modified to estimate both an unknown center frequency and unknown frequency drift rate or alternatively to reformulate the equation set to eliminate them as nuisance parameters.

When neither the center frequency nor the frequency drift rate are known, a few iterations near the correct solution reduce the error. To refine the solution, the Jacobian of the nonlinear equations must be calculated. The frequency model with an unknown frequency and drift rate is:

$$\begin{matrix}{f}_{m} ( t ) = h ( t , θ ) + n ( t ) & ( 4 ) \\ \begin{matrix}f ( t ) = h ( t , θ ) \\ = {f}_{0} ( 1 - \frac{{\dot{r}}_{RT} ( t )}{c} ) + {f}_{d} t\end{matrix} & ( 5 ) \\ = {f}_{0} ( 1 - \frac{{v}_{RT}^{T} ( t ) {u}_{RT} ( t )}{c} ) + {f}_{d} t & ( 6 )\end{matrix}$$

The Jacobian of h(t,θ) with respect to θ is given by:

$$\begin{matrix}∇ h ( t , θ ) = [ ( 1 - \frac{{v}_{RT}^{T} ( t ) {u}_{RT} ( t )}{c} ) t ( \frac{{f}_{0}}{{cr}_{RT} ( t )} ) {v}_{RT}^{T} ( t ) ( I - {u}_{RT} ( t ) {u}_{RT}^{T} ( t ) ) ] & ( 7 ) \\ θ = [ \begin{matrix}{f}_{0} \\ {f}_{d } \\ x\end{matrix} ] & ( 8 )\end{matrix}$$

and details of the Jacobian calculation can be found Sampling at time instants tᵢ the vector equation for the frequency measurement is

$$\begin{matrix}{f}_{m} = [ \begin{matrix}{f}_{m} ( {t}_{1} ) \\ {f}_{m} ( {t}_{2} ) \\ ⋮ \\ {f}_{m} ( {t}_{N } )\end{matrix} ] \\ = [ \begin{matrix}h ( {t}_{1} , θ ) \\ h ( {t}_{2} , θ ) \\ ⋮ \\ h ( {t}_{N } , θ )\end{matrix} ] + [ \begin{matrix}n ( {t}_{1} ) \\ n ( {t}_{2} ) \\ ⋮ \\ n ( {t}_{N } )\end{matrix} ] \\ = h ( θ ) + n\end{matrix} \qquad ( 9 )$$

The Taylor series in θ is about θ₀ for h(θ) is

h(θ)=h(θ₀)+∇h(θ₀)(θ−θ₀)+ . . . (10)

so that the approximate linear equation can be written as

fₘ≈h(θ₀)+∇h(θ₀)(θ−θ₀)+n (11)

The covariance of n is denoted R and n has independent identically distributed components so that

R=σₙ²l (12)

The standard least squares solution to Equation 11, above, leads to a nonlinear Newton type of iteration for θ given by

θₖ₊₁=θₖ+[∇h(θₖ)]^{#}(fₘ−h(θₖ)) (13)

where A^{#} denotes the pseudoinverse of A. The initial θ₀ is provided by the linear geolocation algorithms as a starting point to refine or improve. Equation 13 is a Gauss-Newton solution for θ. By modifying Equation 13, a robust convergence is achieved. More specifically, the step size (from θₖ to θₖ₊₁) in Equation 13 is modified to explicitly put a limit or maximum step size for testing based on a particular application and field of view. This modification is built into the geolocation system 26 allowing for automatic convergence metrics. As such, convergence is achieved without the need for multiple coordinated sources, an antenna array, tight receiver synchronization, or pulsed signals.

With the frequency of the signal estimated, the location of the unknown source is calculated at 116 based on the estimated frequency and as it is measured over time.

This description, rather than describing limitations of an invention, only illustrates an embodiment of the invention recited in the claims. The language of this description is therefore exclusively descriptive and is non-limiting. Obviously, it's possible to modify this invention from what the description teaches. Within the scope of the claims, one may practice the invention other than as described above.

What is claimed is:

1. A geolocation system for identifying a location of an emitting source wherein said geolocation system is hosted by a moving craft, said geolocation system comprising:
an omnidirectional antenna used to collect source signals emitted by the emitting source;
a signal processor in electrical communication with said antenna for receiving the source signal collected by said antenna and for extracting frequency data from the source signal;
a frequency estimator electrically connected to said signal processor, said frequency estimator estimating a frequency of the source signals independent of a center frequency and a frequency drift rate of the source signals; and
an emitter location processor for calculating the location of the emitter source.

2. A geolocation system as set forth in claim 1 including a navigation subsystem for identifying a platform location for the moving craft while said omnidirectional antenna collects source signals.

3. A geolocation system as set forth in claim 2 wherein said signal processor includes a quality estimator for estimating noise in the source signals.

4. A geolocation system as set forth in claim 3 wherein said signal processor includes a modulation detector.

5. A geolocation system as set forth in claim 4 wherein said signal processor includes a plurality of estimators to estimate the frequency of the source signal.

6. A geolocation system as set forth in claim 5 wherein said signal processor includes an estimator selector to select one of said plurality of estimators based on estimations created thereby.

7. A geolocation system as set forth in claim 6 including a platform navigation subsystem supplying platform position and velocity while said antenna is collecting the source signals.

8. A geolocation system as set forth in claim 1 wherein said frequency estimator electrically connected to said signal processor estimates the frequency of the source signals independent of a center frequency and a frequency drift rate of the signal sources when the center frequency of the source signals is unknown and when the frequency drift rate of the source signals is unknown.

9. A method for locating an emitting source while the emitting source is emitting a source signal, the method comprising the steps of:
moving an omnidirectional antenna through a pattern using a moving craft;
receiving the source signal from the emitting source using the omnidirectional antenna;
transmitting the source signal from the omnidirectional antenna to a computerized frequency estimator;
calculating a frequency of the source signal over a period of time in which the antenna is moving using the computerized frequency estimator that employs a Gauss-Newton calculation for step size convergence; and
determining the location of the emitting source based on the frequency measured over time using a computerized geolocation processor.

10. A method as set forth in claim 9 wherein the step of calculating the frequency of the source signal is done independently of a center frequency for the source signal emitted by the emitting source.

11. A method as set forth in claim 10 wherein the step of calculating the frequency of the source signal is done independently of the frequency drift rate for the source signal emitted by the emitting source.

12. A method as set forth in claim 11 wherein the step of calculating the frequency of the source signal is done when the center frequency for the source signal is unknown.

13. A method as set forth in claim 12 wherein the step of calculating the frequency of the source signal is done when the frequency drift rate for the source signal is unknown

14. A method as set forth in claim 9 wherein the step of measuring the frequency includes the step of measuring the Doppler frequency of the source signal.

15. A method as set forth in claim 14 including the step of calculating a position of the omnidirectional antenna while the omnidirectional antenna receives the source signal.

16. A method as set forth in claim 15 wherein the step of moving the omnidirectional antenna through a pattern or platform trajectory which may be but not necessarily repeated.

17. A method as set forth in claim 16 wherein the repeating pattern is a circle.

18. A method as set forth in claim 17 wherein the omnidirectional antenna is a simple omni single element array.

19. A method as set forth in claim 9 wherein the step of calculating includes the step of calculating using non-linear equations.

20. A method as set forth in claim 9 wherein the step of calculating further includes the step of calculating using linear equations.
